(19) United States
(12) Patent Application Publication
(10) Pub. No.: US 2007/0278302 A1
(43) Pub. Date: Dec. 6, 2007

(54) Reading device and reading method

(75) Inventor: Akihiro Wakabayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/528,435

(22) Filed: Sep. 28, 2006

(30) Foreign Application Priority Data
May 31, 2006 (JP) 2006-152450

(51) Int. Cl. G06K 7/10

(52) U.S. Cl. 235/454; 235/462.43

(57) ABSTRACT

A reading device is disclosed for correctly reading signals from an object to be read, such as bar codes of direct marking formed on the surface of a body, such as a metal body, by utilizing light reflected by the body after projecting light onto the object that is to be read. The reading device has a housing which incorporates therein a light-emitting portion projecting light emitted from an internal source of light onto an object to be read, and a light-receiving portion reading the object to be read by receiving light reflected by the object to be read. A diffusion member is mounted on an end portion of the housing to diffuse illumination light from an external source of light, and to transmit illumination light therethrough at a predetermined rate, and to permit illumination light to uniformly fall on the object to be read. The present invention is further concerned with a reading method for correctly reading signals from the object to be read, by using the above reading device and by utilizing light reflected by the body to which light is projected.

### BACKGROUND OF THE INVENTION

1. Field of the Invention

The present invention relates to a reading device for correctly reading signals from an object to be read, such as bar codes of direct marking (i.e., directly marked bar codes) formed on the surface of a body such as a metal body, by utilizing light reflected by the body after light is projected onto the object that is to be read, and to a reading method.

2. Description of the Related Art

In recent years, one-dimensional or two-dimensional bar codes formed by the direct printing on the surface (work surface) of a body such as a metal body, have been widely placed in the market to substitute for bar codes (a kind of object to be read) formed by using paper labels. The one-dimensional or two-dimensional bar codes are usually called bar codes of direct marking, and are formed through simple steps and are more suitable for mass production than bar codes formed by using paper labels.

Here, the bar codes of direct marking are directly printed on the surface of a metal body which causes little light to scatter due to its nearly mirror-like state. When the signals are to be read from the bar codes by using a reading device (e.g., a code reader) called a handy bar code reader, therefore, it often and remarkably becomes difficult to read the bar codes, depending upon the angle of the reading device relative to the bar codes and the direction in which light is projected from an external source of light, such as a ceiling lamp, etc. When the bar codes of direct marking are to be read by using a handy bar code reader which is usually used for the paper labels, therefore, it becomes difficult to guarantee a stable and high reading ability. To cope with this, bar codes of direct marking have been read by using a handy bar code reader for direct marking (i.e., a handy bar code reader for directly marked bar codes) which is provided with a specially designed illumination unit and an optical system.

Here, to allow the problems related to the reading devices and reading methods of the conventional systems to be easily understood, the general constitution of the handy bar code reader of a conventional reading device will now be described with reference to FIGS. 1 to 3 which are described later in the paragraph “BRIEF DESCRIPTION OF THE DRAWINGS”.

A perspective view illustrating the whole constitution of a handy bar code reader for direct marking, is illustrated in FIG. 1. Further, a perspective view illustrating the whole constitution of a general handy bar code reader, that is used for paper labels, is illustrated in FIG. 2.

The handy bar code reader 100 for direct marking shown in FIG. 1 has a housing 1 incorporating therein an internal source of light 3, such as a light-emitting diode (usually abbreviated to LED), which is a point source of light, a grip portion 2 extending from the housing 1, a cable 20 for transmitting signals from the bar code that is read, and a dedicated illumination portion 30 provided along the outer circumferential portion of the housing 1.

In the dedicated illumination portion 30, a plurality of light-emitting elements, such as LEDs, are mounted on the outer circumferential portion of the housing 1, and illumination based on dark visual field illumination is realized by projecting light from the light-emitting elements surrounding a bar code BC of direct marking printed on the surface of a body MS, such as a metal body. When the signals are read from the bar code BC by disposing the thus constituted handy bar code reader 100 for direct marking close to the bar code BC of direct marking, the effect of illumination by dark visual field illumination from the dedicated illumination portion 30 becomes greater than the effect of illumination from the internal source of light 3, and a stable and high reading ability can be guaranteed and is little affected by the illumination light EL (i.e., disturbance light) from an external source of light 9 such as a ceiling lamp.

Further, a general handy bar code reader 110 shown in FIG. 2 has a housing 1 incorporating therein an internal source of light 3, such as an LED, a grip portion 2 extending from the housing 1, and a cable 20 for transmitting signals from the bar code BC that is read. Here, unlike the handy bar code reader 100 for direct marking shown in FIG. 1, no dedicated illumination portion is provided along the outer circumferential portion of the housing 1. Therefore, the effect of illuminating the bar code BC of direct marking is low, and the reading is subject to be affected by the illumination light EL (e.g., disturbance light) from the external source of light 9. Therefore, the ability for reading the bar code BC is inferior to that of the handy bar code reader 100 for direct marking of FIG. 1.

A plan view illustrating examples of two-dimensional bar codes for direct marking, is illustrated in FIG. 3. In the examples of FIG. 3, a plurality of two-dimensional bar codes BC of direct marking are directly printed on the surface of a body MS, such as a metal body. As shown in an enlarged view in FIG. 3, each two-dimensional bar code BC includes a marker MK that serves as a reference for the reading and a two-dimensional bar code pattern BP consisting of black and white patterns specified in advance and formed like a matrix.

When light is projected onto a two-dimensional bar code BC by bringing the handy bar code reader for direct marking or by bringing a general handy bar code reader close to the surface of the body MS, a CCD (charge coupled device) reads signals from the bar code pattern BP included in the reflected light, by utilizing a difference between the reflection factor of light due to white pattern and the reflection factor of light due to black pattern in the bar code pattern BP. Here, a two-dimensional bar code capable of holding a relatively large amount of data is used as a bar code for direct marking that is to be read. Depending upon the cases, however, one-dimensional bar codes can be used. Further, not only the above bar codes but also marks and characters can be directly printed on the surface of the body MS, such as a metal body. These bar codes, marks and characters are generally defined as “objects to be read”.

Next, the features of the handy bar code reader for direct marking of FIG. 1 and the features of the general handy bar code reader of FIG. 2 are compared with each other.

The handy bar code reader for direct marking of FIG. 1 has the following principal features (a) to (e).

(a) A large effect of illumination is exhibited based on dark visual field illumination from a dedicated illumination portion that is additionally provided as an illumination unit. Therefore, the background is dark, the contrast of the bar code is high, and a high reading ability is realized by eliminating the effect of disturbance light reflected by the surface of the body such as a metal body.

(b) To realize the illumination based on visual field illumination, the distance must be considerably shortened between the body and the handy bar code reader for direct marking. In an environment in which the handy bar code reader cannot be brought close to the body such as when protuberances are formed on the surface of the body, it becomes difficult to read the bar codes, and only a decreased number of kinds of bar codes can be read.

(c) The visual field becomes narrow as the distance is considerably shortened between the handy bar code reader and the body, and bar codes of small sizes only can be read. Therefore, only a decreased number of kinds of bar codes can be read, as in the above-mentioned case (b).

(d) The reading direction of the handy bar code reader for the body is limited to the perpendicular direction (just over the body) only, decreasing the degree of freedom in the direction of reading, and decreasing the allowable range concerning the inclination of the handy bar code reader relative to the body.

(e) The structure of the dedicated illumination portion for realizing illumination based on the dark visual field illumination becomes complex, to some extent, resulting in an increase in the production cost of the handy bar code reader and, therefore, the handy bar code reader becomes very expensive.

The price of the handy bar code reader for direct marking is usually about five to six times as high as the price of the general handy bar code reader.

On the other hand, the general handy bar code reader of FIG. 2 has the following principal features (a)′ to (e)′.

(a)′ An internal source of light only is provided as an illumination unit for illumination of bright visual field illumination. Therefore, the effect of illumination for the bar code is low and is subject to be affected by the disturbance light reflected by the surface of the body, such as a metal body (i.e., a stable contrast of the bar code cannot be maintained). Therefore, the bar code reading ability is low.

(b)′ The distance between the general handy bar code reader and the body can be set to be relatively long, and a wide visual field can be maintained. This makes it possible to easily cope with a change in the size of the bar code, and an increased number of kinds of bar codes can be read.

(c)′ The distance can be maintained to be long, to some extent, between the handy bar code reader and the body, and the bar codes can be read even in an environment in which the handy bar code reader cannot be brought close to the body.

(d)′ The degree of freedom increases in the direction in which the handy bar code reader reads the body and, therefore, the body can be easily read even from an angled direction to broaden the allowable range of angles.

(e)′ The illumination unit contains an internal source of light only and is simple. Therefore, the handy bar code reader can be fabricated through simple steps at a decreased cost.

Table 1 below shows the results of comparison of the features of the two types of handy bar code readers described above. In Table 1 below, open circles (◯) indicate that the features of the handy bar code readers are advantageous, while cross marks (X) represent that the advantageous features are not obtained. In Table 1, further, the handy bar code reader for direct marking is abbreviated as “handy reader for direct marking” and the general handy bar code reader is abbreviated as “general handy reader”.

TABLE 1
Results of comparison of the features of
the handy bar code readers.

| | Features | | | | |
|---|---|---|---|---|---|
| | | Number of | | | |
| | | kinds of | | | |
| | | codes that | Distance | Freedom in | |
| | Reading | can be | to the | the reading | |
| Type | ability | read | body | direction | Price |
| Handy reader | high ◯ | small X | short X | low | high X |
| for direct | | | | (just over) X | |
| marking | | | | | |
| General | low X | large ◯ | long ◯ | high ◯ | low ◯ |
| handy reader | | | | | |

As will be obvious from the results of comparison shown in Table 1, the reading device comprising a conventional handy bar code reader for direct marking includes a dedicated illumination portion for illumination based on the dark visual field illumination and is, therefore, capable of realizing a stable and high the reading ability that was difficult to accomplish with the conventional general handy reader. With the handy bar code reader for direct marking, however, the high reading ability is realized by increasing the effect of illumination based on the dark visual field illumination of the dedicated illumination portion, imposing a limitation on the distance to the body, such as the metal body, and on the reading direction relative to the body and, therefore, causing a problem of a great drop in the operability and degree of freedom in reading the bar codes of direct marking. Besides, the structure of the dedicated illumination portion for illumination by the dark visual field illumination becomes complex to some extent, resulting in a very high price for the reading device as a whole.

On the other hand, the reading device comprising a conventional general handy bar code reader includes only a simple internal source of light for illumination, such as bright visual field illumination causing such a problem that the effect of illuminating the bar code is low and is subject to be affected by disturbance light reflected by the surface of the body and that the bar code reading ability is low. This problem becomes conspicuous particularly when the surface of the body is nearly a mirror surface, as in the surface of a metal body. With regard to the operability and degree of freedom in reading the bar codes and the price of the reading device as a whole, however, the general handy bar code reader has many advantages over the handy bar code reader for direct marking. It is, therefore, desired to guarantee a reading ability as high as the handy bar code reader for direct marking while retaining the operability and degree of freedom in reading the bar codes and suppressing the price of the reading device as a whole, as in those of the conventional general handy bar code reader.

For reference, the following patent documents No. 1 and No. 2 are quoted as prior art documents related to the above conventional reading devices.

(1) Patent document No. 1: Japanese Unexamined Patent Publication (Kokai) No. 5-189591

(2) Patent document No. 2: Japanese Unexamined Patent Publication (Kokai) No. 6-162241

The patent document No. 1 discloses the constitution of a bar code scanner in which a light projection optical system is provided forming recessed portions at positions corresponding to a plurality of sources of light arranged in a column on a side facing a source of light 1, so that light from the plurality of sources of light goes out being diffused over a further increased angle, light projected from the projection optical system onto the bar code portion on the surface of the body is rendered to be of a uniform level, and the width in which light is projected maintaining the uniform level is widened in order to read and recognize the bar codes more highly precisely and efficiently.

The patent document No. 2 discloses the constitution of a bar code reading device comprising a light-emitting portion having point sources of light arranged being dispersed to project light onto a bar code directly printed on a metal body or the like, a light-receiving portion for detecting light reflected by the bar code and for converting it into an electric signal, and a translucent diffusion plate covering the light-emitting portion, wherein light from the light-emitting portion is uniformly dispersed by the diffusion plate is projected onto the bar code.

However, neither the patent document No. 1 nor the patent document No. 2 refers to any concrete method of preventing a decrease in the reading ability of bar codes caused by disturbance light from an external source of light, that is reflected by the surface of a body under a condition in which no limitation is imposed on the operability and on the degree of freedom in reading the bar codes of direct marking formed on the surface of the body, such as a metal body, which causes little light to scatter. Therefore, problems which are the same as those of the above-mentioned conventional reading devices may occur in the patent document No. 1 and in the patent document No. 2.

### SUMMARY OF THE INVENTION

The present invention was accomplished in view of the above problems, and provides a reading device which is capable of realizing a high reading ability by excluding the effect of disturbance light reflected by the surface of a body under a condition in which no limitation is imposed on the operability and on the degree of freedom in reading the object to be read, such as bar codes, without driving up the price, at the time of reading signals from an object to be read, by projecting light onto the object to be read, such as bar codes of direct marking formed on the surface of a body such as a metal body, and a reading method.

In order to achieve the above object, a reading device according to one aspect of the present invention has a housing which incorporates therein a light-emitting portion projecting light emitted from an internal source of light onto an object to be read, and a light-receiving portion reading the object to be read by receiving light reflected by the object to be read, wherein a diffusion member is mounted on an end portion of the housing to diffuse illumination light from an external source of light, and to transmit illumination light therethrough at a predetermined rate, and to permit illumination light to uniformly fall on the object to be read.

In the reading device of the present invention, desirably, the diffusion member is detachably attached.

In the reading device of the present invention, more desirably, the angle for mounting the diffusion member is adjustable.

A reading method according to one aspect of the present invention is provided for reading an object to be read by projecting light emitted from an internal source of light onto the object to be read of a body and receiving light reflected by the object to be read, wherein a diffusion member for diffusing illumination light from an external source of light is arranged surrounding the object to be read, and illumination light that has passed through the diffusion member at a predetermined rate is permitted to uniformly fall on the object to be read.

A reading method according to another aspect of the present invention is provided for reading an object to be read by projecting light emitted from an internal source of light onto the object to be read of a body and receiving light reflected by the object to be read, wherein a diffusion member for diffusing illumination light from an external source of light is attached to the external source of light, and illumination light that has passed through the diffusion member at a predetermined rate is permitted to uniformly fall on the object to be read.

As described before, the conventional general handy bar code reader has many advantages over the handy bar code reader for direct marking, and becomes close to an ideal one if the ability for reading the object to be read, such as bar code, could be improved. The general handy bar code reader has a low reading ability because it is based only upon a simple illumination from the internal source of light and is subject to be very easily affected by disturbance light reflected by the surface of a body such as a metal body.

In the present invention, first, therefore, the diffusion member that diffuses illumination light from the external source of light and permits illumination light to pass through at a predetermined rate is attached to an end portion of the housing of the general handy bar code reader. In other words, the directivity of disturbance light is lowered by the diffusion member by positively utilizing disturbance light reflected by the surface of the body, so that light uniformly falls on an opening portion or the like of the handy bar code reader. Therefore, the ability for reading the object to be read, such as bar code, can be greatly improved without being affected by the disturbance light that is reflected by the surface of the body.

In the present invention, second, light falling on the handy bar code reader per se is uniformed by lowering the directivity of disturbance light by arranging a diffusion member surrounding the object to be read, such as bar code, instead of attaching the diffusion member to the general handy bar code reader. Therefore, similarly to the effect of the first invention described above, the ability for reading the object to be read, such as bar code, can be greatly improved without being affected by the disturbance light that is reflected by the surface of the body.

In the present invention, third, light falling on the handy bar code reader per se is uniformed by building an illumination environment of low directivity by attaching the diffusion member to the external source of light (general illumination, such as a ceiling lamp, etc.) that forms an environment for reading the object to be read, such as bar code, instead of mounting the diffusion member on the general handy bar code reader. Therefore, similarly to the effects of the first and second inventions described above, the ability for reading the object to be read, such as bar code, can be greatly improved without being affected by the disturbance light that is reflected by the surface of the body.

In summary, according to the present invention, it is made possible to realize a high reading ability by eliminating the effect of disturbance light reflected by the surface of a body without imposing a limitation on the operability and on the freedom in reading the object to be read, and without driving up the price, by lowering the directivity of disturbance light, by using the diffusion member or the like when the handy bar code reader for direct marking is used at the time of reading signals from the object to be read, such as each of the bar codes of direct marking by projecting light onto the object to be read.

### BRIEF DESCRIPTION OF THE DRAWINGS

The above object and features of the present invention will become more apparent from the following description of some preferred embodiments with reference to the accompanying drawings, wherein:

FIG. 1 is a perspective view illustrating the whole constitution of a handy bar code reader for direct marking;

FIG. 2 is a perspective view illustrating the whole constitution of a general handy bar code reader;

FIG. 3 is a plan view illustrating examples of two-dimensional bar codes for direct marking;

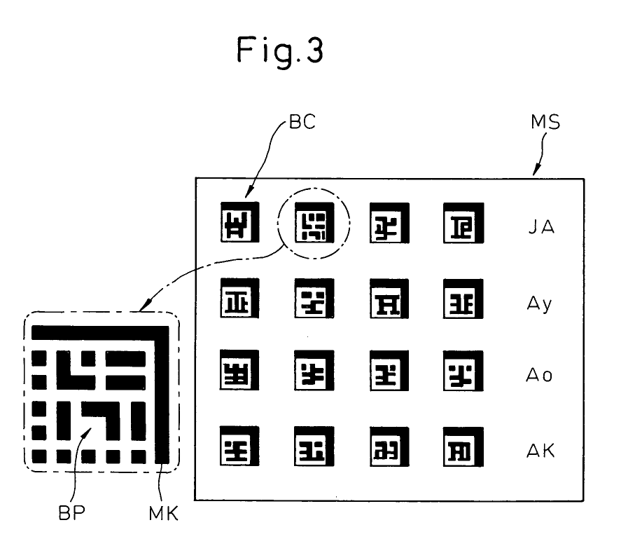

FIG. 4 is a perspective view of when the handy bar code reader for direct marking of FIG. 1 is viewed from the side of the opening portion thereof;

FIG. 5 is a front view illustrating the internal structure of the handy bar code reader for direct marking of FIG. 1;

FIG. 6 is a perspective view of when the general handy bar code reader of FIG. 2 is viewed from the side of the opening portion thereof;

FIG. 7 is a front view illustrating the internal structure of the general handy bar code reader of FIG. 2;

FIG. 8 is a view schematically illustrating the constitution of a reading device according to an embodiment of the present invention;

FIG. 9 is a front view illustrating, on an enlarged scale, the constitution for detachably attaching a diffusion member of FIG. 8;

FIG. 10 is a front view illustrating, on an enlarged scale, the constitution for adjusting the mounting angle of the diffusion member of FIG. 8;

FIG. 11 is a diagram schematically illustrating a reading method according to an embodiment of the present invention; and

FIG. 12 is a diagram schematically illustrating the reading method according to another embodiment of the present invention.

### DESCRIPTION OF THE PREFERRED EMBODIMENTS

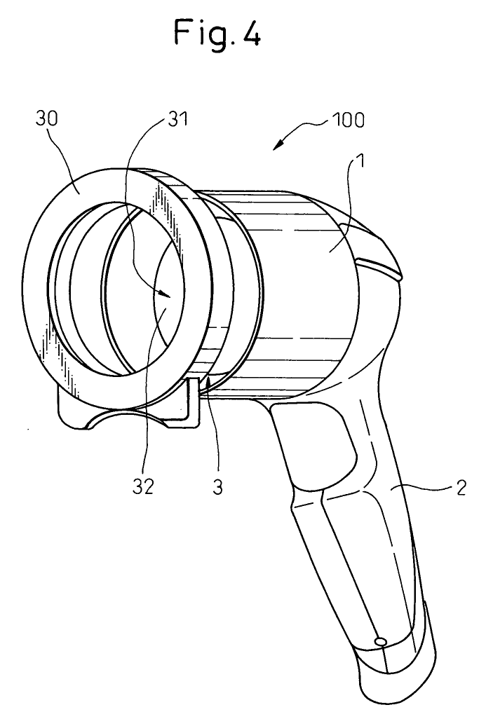

Here, prior to describing the reading device and the reading method according to the embodiment of the present invention, described below in detail with reference to the accompanying drawings (FIGS. 4 to 7) are the structure of a conventional handy bar code reader for direct making and of a general handy bar code reader on the side of the opening portion, and the internal structure thereof, that serve as a prerequisite for the present invention.

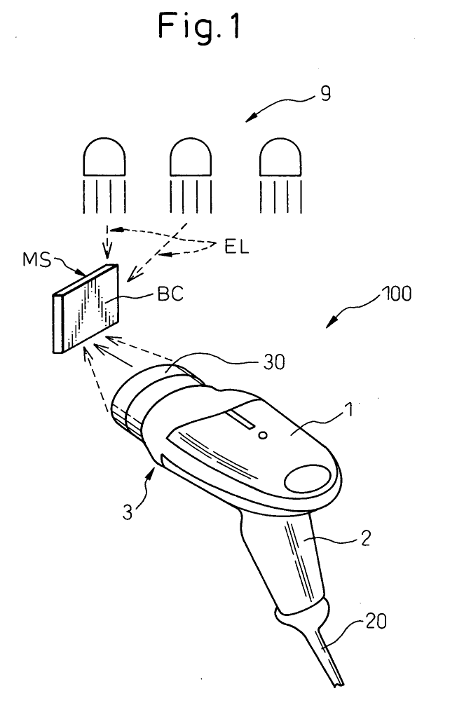

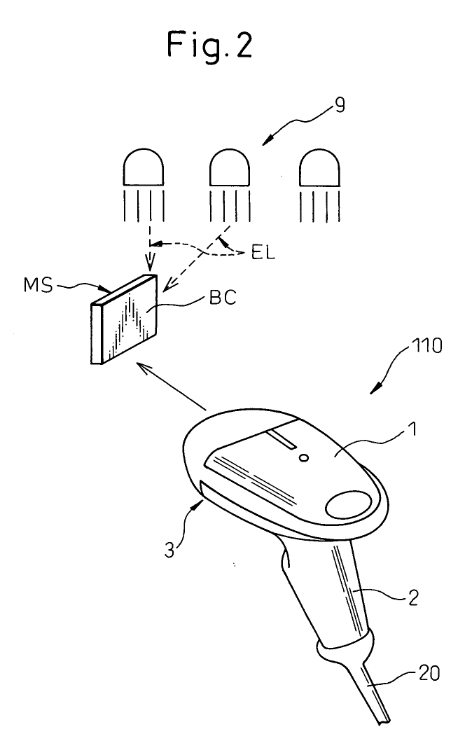

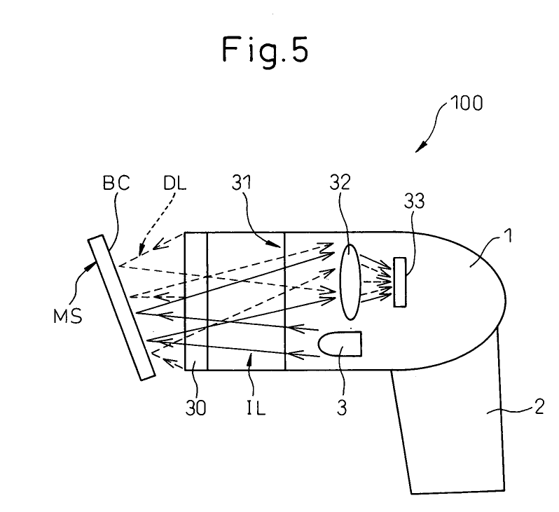

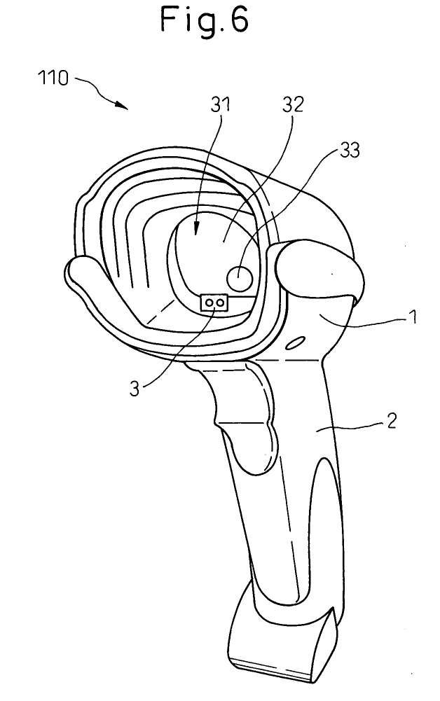

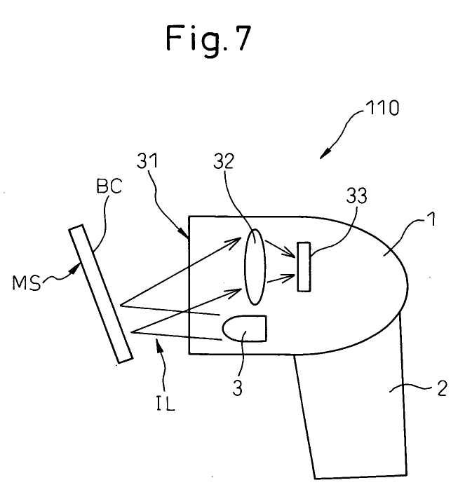

FIG. 4 is a perspective view of when the handy bar code reader for direct marking of FIG. 1 is viewed from the side of the opening portion thereof; FIG. 5 is a front view illustrating the internal structure of the handy bar code reader for direct marking of FIG. 1; FIG. 6 is a perspective view of when the general handy bar code reader of FIG. 2 is viewed from the side of the opening portion thereof; and FIG. 7 is a front view illustrating the internal structure of the general handy bar code reader of FIG. 2.

Illustrated here are the structures of the conventional handy bar code reader 100 for direct marking and of the general handy bar code reader 110 on the side of the opening portions and the internal structures thereof. Hereinafter, the same constituent elements as those described above will be denoted by the same reference numerals.

As in the handy bar code reader of FIG. 1 described above, the handy bar code reader 100 for direct marking shown in FIGS. 4 and 5 has a housing 1 incorporating therein an internal source of light 3, such as an LED which is a point sources of light, a grip portion 2, and a dedicated illumination portion 30 provided along the outer circumferential portion of the housing 1. An opening portion 31 made of a transparent resin plate or a glass plate is provided at the back of the dedicated illumination portion 30 but at an end portion of the housing 1.

Inside the housing 1, there are mounted a light-emitting portion projecting light IL emitted from the internal source of light 3 to a bar code BC of direct marking printed on the surface of a body MS, such as a metal body, a light-receiving lens 32 receiving light reflected by the bar code BC, and a light-receiving portion 33 reading signals from the bar code BC by receiving light focused by the light-receiving lens 32. The light-receiving portion 33 has a function of reading signals from the bar code BC by converting signals of light focused by the light-receiving lens 32 into electric signals, and is, desirably, constituted by a CCD or a CMOS (complementary metal oxide semiconductor) element. Here, light emitted from the internal source of light 3 or light reflected by the bar code BC propagates passing through the opening portion 31.

In the dedicated illumination portion 30 shown in FIGS. 4 and 5, further, a plurality of light-emitting elements (not shown), such as LEDs, are uniformly arranged along the outer cirumerential portion of the housing 1. Light DL emitted from the light-emitting elements is projected onto the bar code BC from the surrounding of the bar code BD of direct marking printed on the surface of the body MS. When the handy bar code reader 100 for direct marking is disposed close to the bar code BC of direct marking, the bar code BC of direct marking is illuminated by the dark visual field illumination, due to light DL emitted from the light-emitting elements. As will be obvious from the state of illuminating the bar code BC in FIG. 5, when the signals are read from the bar code BC of direct marking by using the handy bar code reader 100 for direct marking, the effect of illumination by the dark visual field illumination, due to light DL from the dedicated illumination portion 30, becomes greater than the effect of illumination by light IL from the internal source of light 3. This guarantees a stable and high reading ability without it being affected by the disturbance light reflected by the surface of the body MS.

In the handy bar code reader 100 for direct marking shown in FIGS. 4 and 5, a high reading ability is realized by increasing the effect of illumination by the dark visual field illumination of the dedicated illumination portion 30 imposing, however, a limitation on the distance to the body MS and on the reading direction for the body MS causing a great decrease in the operability and in the degree of freedom in reading the bar code BC of direct marking. Besides, to accomplish the illumination by the dark visual field illumination, a plurality of light-emitting elements, such as LEDs, must be uniformly arranged causing the structure of the dedicated illumination portion 30 to become complex to some extent and, hence, remarkably increasing the price of the reading device which comprises a handy bar code reader.

As in the handy bar code reader of FIG. 2 described above, further, the general handy bar code reader 110 shown in FIGS. 6 and 7 has a housing 1 incorporating therein an internal source of light 3, such as an LED, which is a point source of light, and a grip portion 2. An opening portion 31 made of a transparent resin plate or a glass plate is provided at an end portion of the housing 1.

Inside the housing 1, there are mounted a light-emitting portion projecting light IL emitted from the internal source of light 3 to a bar code BC of direct marking printed on the surface of a body MS, a light-receiving lens 32 receiving light reflected by the bar code BC, and a light-receiving portion 33 reading signals from the bar code BC by receiving light focused by the light-receiving lens 32, as in the handy bar code reader 100 for direct marking, of FIGS. 4 and 5, described above. Here, light IL emitted from the internal source of light 3 or light reflected by the bar code BC propagates passing through the opening portion 31.

In the general handy bar code reader 110 of FIGS. 6 and 7, however, no dedicated illumination portion is provided along the outer circumferential portion of the housing 1, unlike the handy bar code reader 100 for direct marking, of FIGS. 4 and 5, described above.

In other words, in the general handy bar code reader 110, only simple illumination is accomplished by light IL emitted from the internal source of light 3 which is the point source of light, which is subject to be easily affected by disturbance light reflected by the surface of the body MS. Therefore, its ability for reading the bar code BC of direct marking printed on the surface of the body MS tends to become lower than that of the handy bar code reader 100 for direct marking, of FIGS. 4 and 5, described above. This tendency becomes conspicuous particularly when the surface of the body MS is nearly a mirror surface, as is the surface of the metal body.

As will be obvious from the results of comparison in Table 1 described above, however, the general bar code handy reader shown in FIGS. 6 and 7 has many advantages over the handy bar code reader for direct marking of FIGS. 4 and 5, except for a poor ability for reading the bar codes. In the present invention, therefore, it is desired to provide a reading device which is capable of guaranteeing a high reading ability nearly equal to that of the handy bar code reader for direct marking, by improving the structure and arrangement of the general handy bar code reader of FIGS. 6 and 7.

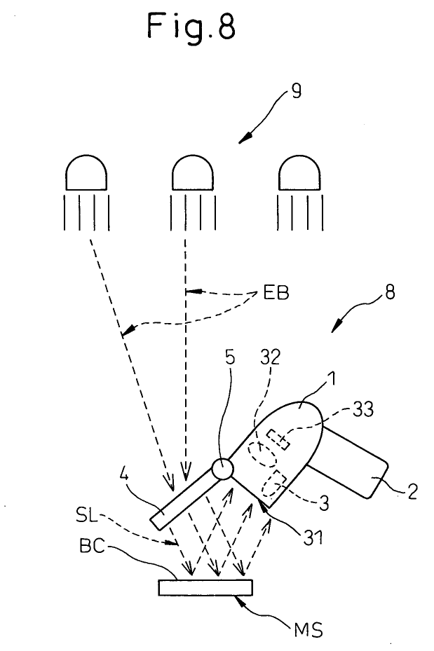

Next, a reading device and a reading method according to preferred embodiments of the present invention contrived from the above point of view will be described with reference to the accompanying drawings (FIGS. 8 to 12).

FIG. 8 is a view schematically illustrating the constitution of the reading device according to an embodiment of the present invention. Here, the constitution of the reading device 8 according to the embodiment of the present invention is illustrated in a simplified manner.

As in the general handy bar code reader, of FIGS. 6 and 7, described above, the reading device 8 according to the embodiment of FIG. 8 has a housing 1 incorporating therein an internal source of light 3, such as an LED, and a grip portion 2 extending from the housing 1. An opening portion 31 made of a transparent resin plate or a glass plate is provided at an end portion of the housing 1.

Inside the housing 1, there are mounted a light-emitting portion projecting light emitted from the internal source of light 3 to a bar code BC of direct marking printed on the surface of a body MS, such as a metal body, a light-receiving lens 32 receiving light reflected by the bar code BC, and a light-receiving portion 33 reading signals from the bar code BC by receiving light focused by the light-receiving lens 32, as in the general handy bar code reader 100, of FIGS. 6 and 7, described above.

In the reading device 8 of the embodiment of FIG. 8, a diffusion member 4 for diffusing illumination light EB from an external source of light 9 (e.g., general light, such as ceiling lamps and the like) is attached to an end of the housing 1 via a mounting portion 5. The diffusion member 4 permits illumination light EB from the external source of light 9 to diffuse at a predetermined rate and to pass through at a predetermined rate, so as to uniformly fall as disturbance light SL on the bar code BC on the surface of the body MS. Desirably, the diffusion member 4 is made of a resin plate or a glass plate of which the surface has been delustered. Disturbance light SL that has fallen on the surface of the body MS through the diffusion member 4 is reflected by the bar code BC on the surface thereof and arrives at the light-receiving lens 32 and the light-receiving portion 33 through the opening portion 31.

In the general handy bar code reader as described above, only simple illumination is accomplished by light emitted from the internal source of light 3, which is subject to be easily affected by disturbance light SL reflected by the bar code BC on the surface of the body MS. Therefore, contrast of the bar code decreases and the ability for reading the bar code decreases, too.

In the reading device 8 according to the embodiment of FIG. 8, on the other hand, light falls uniformly on the light-receiving lens 32 and on the light-receiving portion 33 in the reading device, by positively utilizing the disturbance light SL reflected by the bar code BC on the surface of the body MS and by lowering the directivity of disturbance light SL through the diffusion member 4. This eliminates the effect of disturbance light SL reflected by the surface of the body MS, enhances the contrast of the bar bode, and greatly enhances the ability for reading the object to be read, such as bar code.

The reading device of FIG. 8 is used for reading the bar codes formed on the surface of the body but can further be used for reading marks and characters formed on the surface of the body.

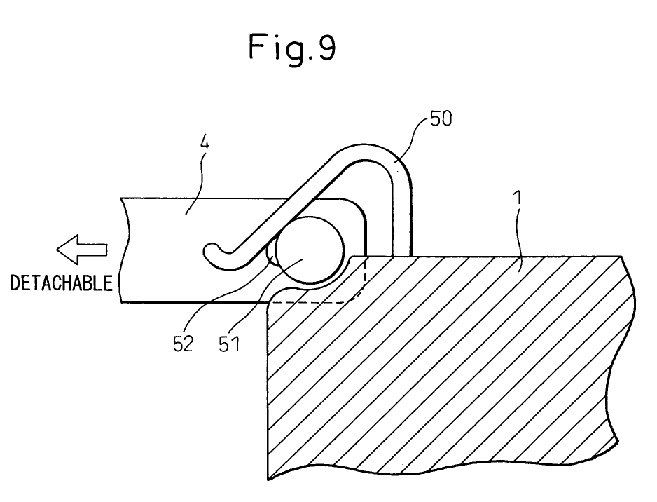

FIG. 9 is a front view illustrating, on an enlarged scale, the constitution for detachably attaching the diffusion member of FIG. 8. Illustrated here on an enlarged scale and in a simplified manner is the constitution by which the diffusion member 4 is detachably attached to the housing 1 of the reading device 8 of FIG. 8.

In FIG. 9, a support shaft 51 is formed in a portion of the diffusion member 4. Further, a cam 52 is formed on the support shaft 51, the support shaft 51 and the cam 52 being allowed to rotate with respect to the housing 1. Further, a resilient member 50, such as a hinged spring, is provided on the housing 1.

In this constitution, the support shaft 51 is held by the resilient force of the resilient member 50 to thereby attach the diffusion member 4 to the housing 1 at a predetermined mounting angle. Further, the diffusion member 4 can be easily and detachably attached to the housing 1, depending upon the position of the cam 52 formed on the support shaft 51. When the cam 52 is, for example, at a position shown in FIG. 9, the diffusion member 4 is pulled in a direction of an arrow so as to be easily detached from the housing 1. When the diffusion member 4 that is once detached from the housing 1 is to be attached to the housing 1 again, the cam 52 is set at the above position and the diffusion member 4 is easily mounted on the housing 1.

When a plurality of kinds of bar codes BC (see FIG. 8) are formed on the surface of the body MS (see FIG. 8), in general, the contrasting state of the bar code differs depending upon the positions of the bar codes, and a situation may occur in which the diffusion member does not have to be attached for some bar codes.

To cope with the above situation, the constitution shown in FIG. 9 is employed in order to easily and detachably attach the diffusion member 4 to the housing 1, depending upon whether or not the diffusion member 4 is required for each of the bar codes.

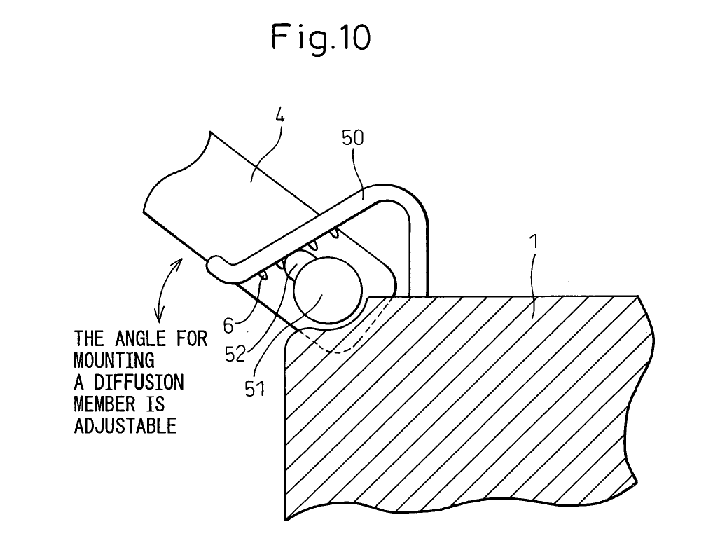

FIG. 10 is a front view illustrating, on an enlarged scale, the constitution for adjusting the mounting angle of the diffusion member of FIG. 8. Illustrated here on an enlarged scale and in a simplified manner is the constitution by which the angle is adjustable for mounting the diffusion member 4 on the housing 1 in the reading device 8 of FIG. 8.

In FIG. 10, too, a support shaft 51 is formed in a portion of the diffusion member 4, as in the case of FIG. 9 described above. Further, a cam 52 is formed on the support shaft 51 and the support shaft 51 and the cam 52 can rotate with respect to the housing 1. Further, a resilient member 50 such as a hinged spring is provided on the housing 1. Moreover, a plurality of protuberances 6 are formed maintaining a predetermined gap on the resilient member 50 at positions in which the resilient member 50 comes in contact with the cam 52.

In this constitution, the support shaft 51 is held by the resilient force of the resilient member 50 to thereby bring the protuberances 6 on the resilient member 50 into engagement with the cam 52 at a position selected in advance, in order to attach the diffusion member 4 to the housing 1 in a state in which the mounting angle of the diffusion member 4 is suitably set with respect to the housing 1. Further, the angle of mounting the diffusion member 4 on the housing 1 is arbitrarily adjusted by varying the position in which the protuberances 6 of the resilient member 50 come into engagement with the cam 52. In this case, too, the diffusion member 4 can be easily and detachably attached to the housing 1, depending upon the position of the cam 52 formed on the support shaft 51, as in the case of FIG. 9 described above.

When a plurality of kinds of bar codes BC (see FIG. 8) are formed on the surface of the body MS (see FIG. 8), in general, the contrasting state of the bar code differs depending upon the angle of the housing 1 with respect to the individual bar codes or upon the positions (or angles) in which the illumination light from the external source of light falls on the surface of the body, and a situation may occur in which the angle for mounting the diffusion member 4 on the housing 1 must be varied.

To cope with the above situation, the constitution shown in FIG. 10 is employed in order to easily adjust the angle for mounting the diffusion member 4 on the housing 1, depending upon the angle of the housing 1 with respect to the bar code or upon the position in which the illumination light from the external source of light is falling on the surface of the body.

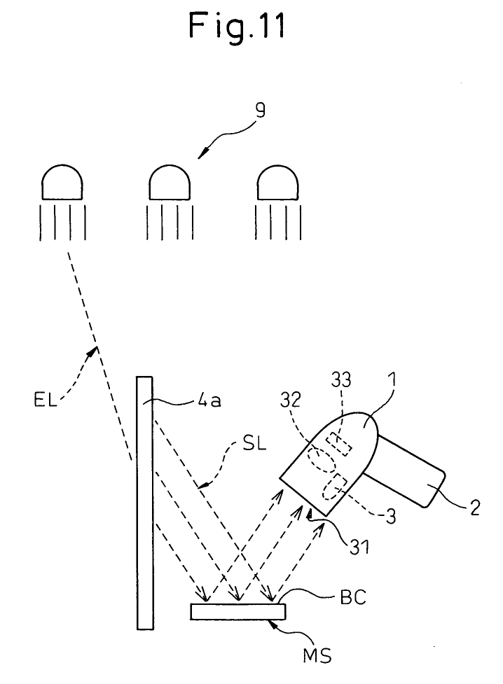

FIG. 11 is a diagram schematically illustrating a reading method according to an embodiment of the present invention. Illustrated here in a simplified manner is the reading method for reading bar codes BC of direct marking according to an embodiment of the present invention.

As in the case of FIGS. 6 and 7 described above, FIG. 11 uses the general handy bar code reader having a housing 1 which incorporates therein an internal source of light 3, such as an LED, and a grip portion 2 extending from the housing 1. An opening portion 31 made of a transparent resin plate or a glass plate is provided at an end portion of the housing 1.

Inside the housing 1, there are mounted a light-emitting portion projecting light emitted from the internal source of light 3 to a bar code BC of direct marking printed on the surface of a body MS, a light-receiving lens 32 receiving light reflected by the bar code BC, and a light-receiving portion 33 reading signals from the bar code BC by receiving light focused by the light-receiving lens 32, as in the case of FIGS. 6 and 7 described above.

In FIG. 11, further, a diffusion member 4a for diffusing illumination light EB from an external source of light 9 (e.g., general light, such as ceiling lamps and the like) is arranged surrounding (or surrounding only part of) the bar code BC of direct marking printed on the surface of the body MS. Here, illumination light EL that is diffused at a predetermined rate through the diffusion member 4a and has passed through the diffusion member 4a at a predetermined rate, is permitted to uniformly fall as disturbance light SL on the bar code BC on the surface of the body MS. Disturbance light SL that has fallen on the surface of the body MS through the diffusion member 4a is reflected by the bar code BC on the surface thereof and arrives at the light-receiving lens 32 and the light-receiving portion 33 through the opening portion 31.

According to the reading method of the embodiment of FIG. 11, light falls uniformly on the light-receiving lens 32 and on the light-receiving portion 33 in the general handy bar code reader by lowering the directivity of disturbance light SL, by arranging the diffusion member 4a surrounding the bar code BC on the surface of the body MS instead of attaching the diffusion member to the general handy bar code reader. This eliminates the effect of disturbance light reflected by the surface of the body, and greatly enhances the ability for reading the object to be read, such as bar code, as in the case of FIG. 8 described above.

According to the reading method of the embodiment of FIG. 11, directivity of disturbance light is lowered by simply arranging the diffusion member surrounding the body without varying the structure of the general handy bar code reader. Therefore, the ability for reading bar codes can be improved by a method simpler than that in the case of FIG. 8 described above.

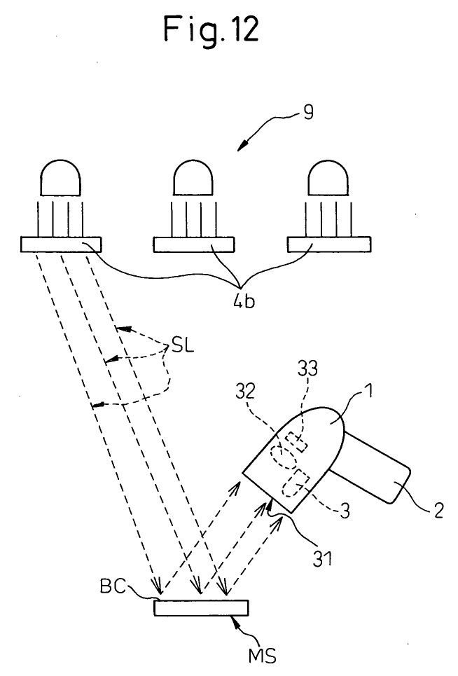

FIG. 12 is a diagram schematically illustrating the reading method according to another embodiment of the present invention. Illustrated here in a simplified manner is the reading method for reading bar codes BC of direct marking according to another embodiment of the present invention.

As in the case of FIGS. 6 and 7 described above, FIG. 12 uses the general handy bar code reader having a housing 1 which incorporates therein an internal source of light 3, such as an LED, and a grip portion 2 extending from the housing 1. An opening portion 31 made of a transparent resin plate or a glass plate is provided at an end portion of the housing 1.

Inside the housing 1, there are mounted a light-emitting portion projecting light emitted from the internal source of light 3 to a bar code BC of direct marking printed on the surface of a body MS, a light-receiving lens 32 receiving light reflected by the bar code BC, and a light-receiving portion 33 reading signals from the bar code BC by receiving light focused by the light-receiving lens 32, as in the case of FIGS. 6 and 7 described above.

In FIG. 12, further, diffusion members 4b for diffusing illumination light from external sources of light 9 (e.g., general light, such as ceiling lamps and the like) are attached to the external sources of light themselves (or near to the external sources of light). Here, disturbance light SL that is diffused at a predetermined rate through the diffusion members 4b and has passed through the diffusion members 4b at a predetermined rate, is permitted to uniformly fall on the bar code BC on the surface of the body MS. Disturbance light SL that has fallen on the surface of the body MS is reflected by the bar code BC on the surface thereof and arrives at the light-receiving lens 32 and the light-receiving portion 33 through the opening portion 31.

According to the reading method of the embodiment of FIG. 12, light falls uniformly on the light-receiving lens 32 and on the light-receiving portion 33 in the general handy bar code reader, by building an illumination environment of low directivity by attaching the diffusion members 4b to the external sources of light themselves that form an environment for reading the bar codes instead of attaching the diffusion member to the general handy bar code reader. This eliminates the effect of disturbance light reflected by the surface of the body, and greatly enhances the ability for reading the object to be read, such as bar code, as in the case of FIGS. 8 and 11 described above.

According to the reading method of the embodiment of FIG. 12, directivity of disturbance light is lowered by simply attaching the diffusion members to the external sources of light forming the environment for reading bar codes without varying the structure of the general handy bar code reader. Therefore, the ability for reading the bar codes can be improved by a method simpler than that in the case of FIG. 8 described above.

With regard to the industrial applicability, the present invention is applied to a handy bar code reader of any type which is capable of realizing a high reading ability by excluding the effect of disturbance light, at the time of reading signals from an object to be read, by projecting light onto the object to be read, such as bar codes of direct marking formed on the surface of the body, such as a metal body, and by utilizing light reflected by the surface of the body.

1. A reading device having a housing which incorporates therein a light-emitting portion projecting light emitted from an internal source of light onto an object to be read, and a light-receiving portion reading said object to be read by receiving light reflected by said object to be read, wherein a diffusion member is mounted on an end portion of said housing to diffuse illumination light from an external source of light, and to transmit illumination light therethrough at a predetermined rate, and to permit illumination light to uniformly fall on said object to be read.

2. A reading device according to claim 1, wherein said body is a metal body, and said object to be read is one that is directly printed on said metal body.

3. A reading device according to claim 1, wherein said diffusion member is detachably attached.

4. A reading device according to claim 3, wherein said body is a metal body, and said object to be read is one that is directly printed on said metal body.

5. A reading device according to claim 1, wherein the angle for mounting said diffusion member is adjustable.

6. A reading device according to claim 5, wherein said body is a metal body, and said object to be read is one that is directly printed on said metal body.

7. A reading device having a housing which incorporates therein a light-emitting portion projecting light emitted from an internal source of light onto an object to be read, and a light-receiving portion reading said object to be read by receiving light reflected by said object to be read, wherein a diffusion member is arranged surrounding said object to be read so that illumination light from an external source of light is diffused, and passed through at a predetermined rate, and is permitted to uniformly fall on said object to be read.

8. A reading device according to claim 7, wherein said body is a metal body, and said object to be read is one that is directly printed on said metal body.

9. A reading device having a housing which incorporates therein a light-emitting portion projecting light emitted from an internal source of light onto an object to be read, and a light-receiving portion reading said object to be read by receiving light reflected by said object to be read, wherein a diffusion members are attached to external sources of light so that illumination light from said external sources of light is diffused, and passed through at a predetermined rate, and is permitted to uniformly fall on said object to be read.

10. A reading device according to claim 9, wherein said body is a metal body, and said object to be read is one that is directly printed on said metal body.

11. A reading method for reading an object to be read by projecting light emitted from an internal source of light onto the object to be read of a body and by receiving light reflected by said object to be read, wherein a diffusion member for diffusing illumination light from an external source of light is arranged surrounding said object to be read, and illumination light that has passed through said diffusion member at a predetermined rate is permitted to uniformly fall on said object to be read.

12. A reading method according to claim 11, wherein said body is a metal body, and said object to be read is one that is directly printed on said metal body.

13. A reading method for reading an object to be read by projecting light emitted from an internal source of light onto said object to be read of a body and by receiving light reflected by said object to be read, wherein diffusion members for diffusing illumination light from external sources of light are attached to said external sources of light, and illumination light that has passed through said diffusion members at a predetermined rate is permitted to uniformly fall on said object to be read.

14. A reading method according to claim 13, wherein said body is a metal body, and said object to be read is one that is directly printed on said metal body.
